(19) United States
(12) Patent Application Publication
(10) Pub. No.: US 2009/0056747 A1
(43) Pub. Date: Mar. 5, 2009

(54) FAN BLADE CLEANING TOOL AND METHOD

(76) Inventor: John C. MARSHALL, Greenwell Springs, LA (US)

Correspondence Address: BERENATO, WHITE & STAVISH, LLC, 6550 ROCK SPRING DRIVE, SUITE 240, BETHESDA, MD, 20817, US

(21) Appl. No.: 12/111,705

(22) Filed: Apr. 29, 2008

Related U.S. Application Data
(62) Division of application No. 10/718,690, filed on Nov. 24, 2003, now Pat. No. 7,363,674.

(51) Int. Cl. B08B 7/00

(52) U.S. Cl. 134/6

(57) ABSTRACT

The present invention is directed to a fan blade cleaning tool having a box-shaped housing. The housing has first and second openings on opposing sides, with a passage extending therebetween for receiving a fan blade. A dust gutter extends outwardly from, and adjacent to, the first opening. A method of cleaning a fan blade using the disclosed tool is also provided.

### FIELD OF THE INVENTION

The present invention is directed to a fan blade cleaning tool having a box-shaped housing. The housing has first and second openings on opposing sides, with a passage extending therebetween for receiving a fan blade. A dust gutter extends outwardly from, and adjacent to, the first opening. A method of cleaning a fan blade using the disclosed tool is also provided.

### BACKGROUND OF THE INVENTION

Various designs for fan blade cleaning tools have been developed. Some conventional designs include a cleaning head having a tubular cleaning cloth secured between two prongs. The cleaning head is attached to a handle. Other designs include an arm extending perpendicularly from one end of the handle, with a cleaning cloth or brush secured to the arm. Such designs are difficult to maneuver onto or around the fan blade, and often fail to adequately clean the fan blade.

Other designs include a housing structure having a passage through which a fan blade is passed. Brushes are provided within the housing for cleaning the blade. Unfortunately, the brushes often push debris and dust from the fan blade surface onto the floor below. In addition, such designs typically include a relatively narrow passage opening. As such, it is often difficult to maneuver the fan blade into the passage.

Other designs have been developed for use with a vacuum cleaner. However, such designs are overly complex, and require a user to lug the vacuum cleaner around when cleaning fan blades. In addition, the vacuum cleaner must be equipped with the appropriate length of tubing for attaching the cleaning apparatus.

### SUMMARY OF THE INVENTION

The present invention is directed to a fan blade cleaning tool having a box-shaped housing. The housing has first and second openings on opposing sides, with a passage extending therebetween for receiving a fan blade. A dust gutter extends outwardly from, and adjacent to, the first opening.

A method of cleaning a fan blade is also disclosed. A fan blade is passed through a passage extending through a box shaped housing. Opposing major surfaces of the fan blade are simultaneously cleaned while passing the blade through the passage. Debris is collected from the opposing major surfaces of the fan blade in a dust gutter.

### BRIEF DESCRIPTION OF THE DRAWINGS

FIG. 1 is a perspective view of a fan blade cleaning tool according to a first embodiment of the present invention, with a fan blade positioned within a housing of the tool;

FIG. 2 is a perspective view of the housing of the cleaning tool according to the first embodiment;

FIG. 3 is a cross-sectional view of the cleaning tool according to the first embodiment;

FIG. 4 is a perspective view of the cleaning tool according to the first embodiment, with a fan blade proximate the housing; and

FIG. 5 is another perspective view of the cleaning tool according to the first embodiment.

### DETAILED DESCRIPTION OF THE INVENTION

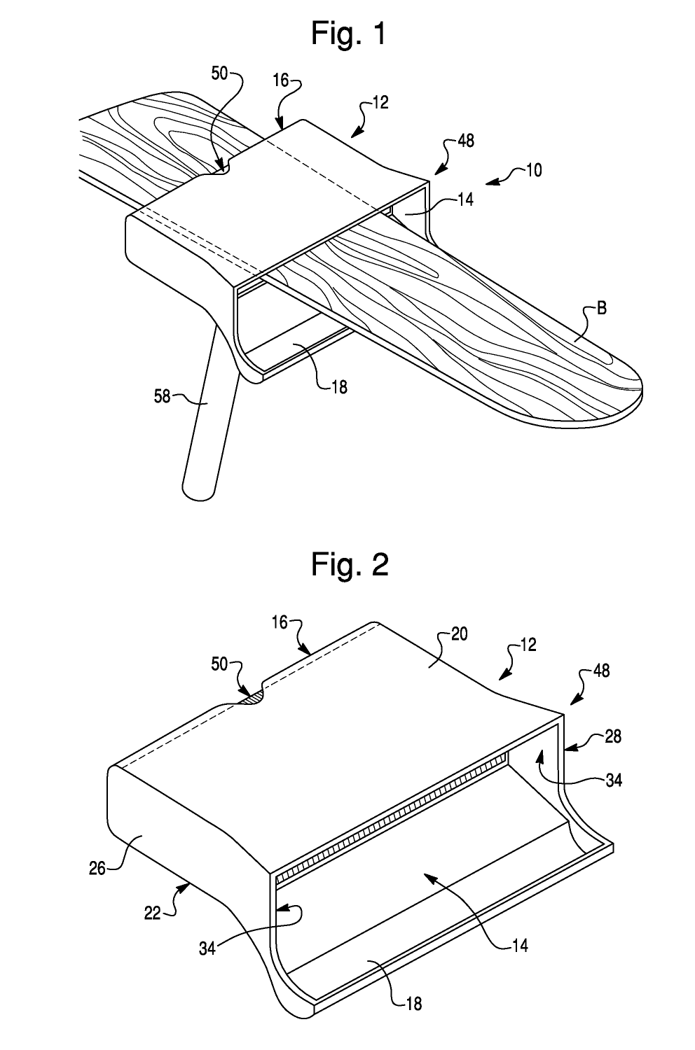

As best shown in FIG. 1, a fan blade cleaning tool 10 according to a first embodiment comprises a box-shaped housing having first and second openings 14, 16 on opposing sides with a passage extending therebetween for receiving a fan blade B. A dust gutter 18 extends outwardly from, and adjacent to, first opening 14.

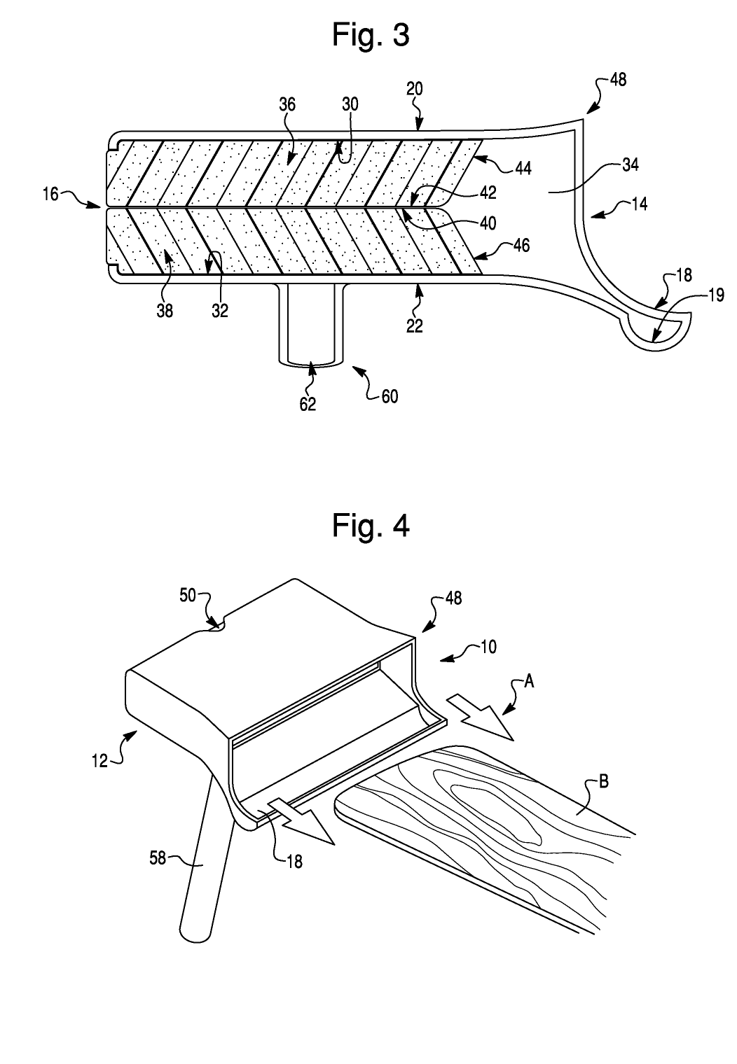

As best shown in FIGS. 2 and 3, housing 12 comprises a first major planar surface 20 spaced from a second major planar surface 22. Sidewalls 26, 28 extend between first and second major surfaces 20, 22. Sidewalls 26, 28 may be substantially perpendicular to first and second major surfaces 20, 22. Opposing first and second inner surfaces 30, 32, and inner sidewalls 34, define the passage extending between first and second openings 14, 16. Dust gutter 18 extends outwardly from second major surface 22. Housing 12 and dust gutter 18 may be integrally formed of plastic.

Cleaning tool 10 may also include first and second cleaning pads 36, 38, as best shown in FIG. 3. Pads 36, 38 may be formed from foam, or some other sponge-like material that is resiliently deformable. Pads 36, 38 are removably securable within the passage. First pad 36 is adjacent first inner surface 30, and second pad 38 is adjacent second inner surface 32.

First and second pads 36, 38 may be easily pushed into place within the passage, and form a fit within the passage so that the passage is completely blocked by pads 36, 38. However, a fan blade B may be pushed through the passage, as best shown in FIG. 1. Pads 36, 38 deform to allow the fan blade B to pass through the passage. Cleaning surfaces 40, 42 of pads 36, 38, respectively, are in contact with opposing sides of the fan blade B. Pads 36, 38 provide sufficient force against the fan blade B to push any debris and dust off of the opposing blade surfaces. Some of the debris is retained by pads 36, 38. Any excess debris that is not retained by pads 36, 38 is pushed into dust gutter 18 as cleaning tool 10 is pulled away from the fan blade B, as best shown by arrows A in FIG. 4. Opposing sides of the fan blade B are simultaneously cleaned by pads 36, 38. Dust and debris is collected by pads 36, 38 and dust gutter 18, thereby minimizing the possibility of debris falling to the floor below when cleaning fan blade B. As best shown in FIG. 3, dust gutter 18 may lie on a plane spaced from second major planar surface 22, so that dust gutter 18 is below second major planar surface 22 when cleaning tool 10 is being used to clean a ceiling fan blade B. Dust gutter 18 may include a curved base 19, which is relatively easy for a user to wipe clean after use.

Preferably, first and second pads 36, 38 include beveled leading edges 44, 46, which are proximate first opening 14, as best shown in FIG. 3. Beveled leading edges 44, 46 help to direct the fan blade B into position between cleaning surfaces 40, 42 and through the passage. Pads 36, 38 may have substantially identical dimensions. In this way, manufacturing considerations are simplified. In addition, installation and replacement for a user is simplified. Pads 36, 38 may be moistened with a cleaning fluid for additional cleaning power. Pads 36, 38 may also be moistened with a polishing fluid, so that the fan blade B is simultaneously cleaned and polished as it passes between cleaning surfaces 40, 42.

Housing 12 may include a flared end 48, wherein first and second major planar surfaces 20, 22 and sidewalls 26, 28 flare outwardly toward first opening 14, as best shown in FIGS. 1-5. In this way, first opening 14 is larger than second opening 16. Flared end 48 helps to direct the fan blade B into first opening 14. Thus, flared end 48 and beveled leading edges 44, 46 direct the fan blade B through the passage of housing 12.

As best shown in FIGS. 1-2 and 4-5, housing 12 may also include indented portions 50, 52 extending inwardly along edges 54, 56 of first and second major planar surfaces 20, 22, proximate second opening 16. Indented portions 50, 52 extend into first and second major planar surfaces 20, 22, so that portions of pads 36, 38 that are adjacent first and second inner surfaces 30, 32 of housing 12 are exposed. Indented portions 50, 52 extend inwardly from edges 54, 56 a sufficient amount to allow a user to grasp pads 36, 38 with two fingers. Pads 36, 38 may be easily grasped in the exposed portions of pads 36, 38, pinched between two fingers, and removed for replacement.

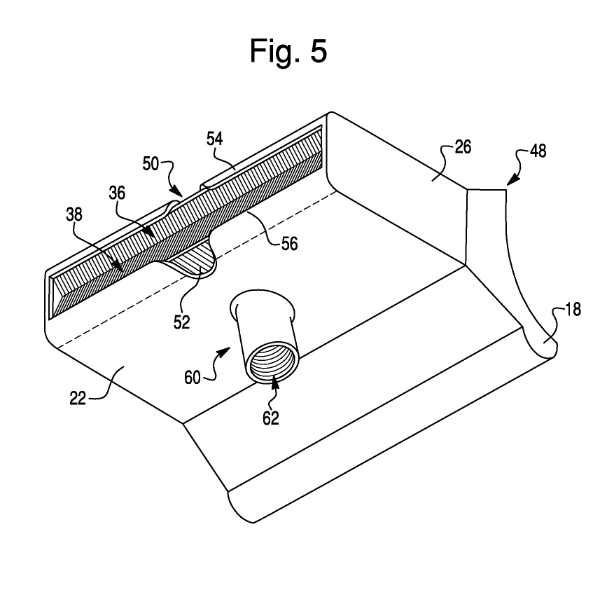

Cleaning tool 10 may also include a handle 58 extending from housing 12, as best shown in FIGS. 1 and 4. In one embodiment, a tubular member 60 extends outwardly from second major surface 22, as best shown in FIGS. 3 and 5. Tubular member 60 includes an opening 62 and passage for receiving a conventional broom handle, or similar elongate handle. The passage may extend substantially perpendicular to second major surface 22, so that the handle will extend outwardly from, and substantially perpendicular to, second major surface 22. The passage may be threaded, so that a conventional broom handle may be screwed into the passage. Alternatively, a pin may be screwed through tubular member 60 and into a handle positioned within the passage. The handle may be releasably securable within the passage of tubular member 50.

Certain aspects of the present invention have been explained according to embodiments of the present invention. It will be apparent to one of ordinary skill in the art that various modifications can be made in construction or configuration of the present invention without departing from the scope or spirit of the invention. Therefore, it is intended that the present invention include all such modifications and variations, provided they come within the scope of the following claims and their equivalents.

1-25. (canceled)

26. A method of cleaning a fan blade comprising:
passing a fan blade through a passage extending through a box shaped housing while simultaneously cleaning opposing major surfaces of the fan blade; and
collecting debris from opposing major surfaces of the fan blade in a dust gutter during the passing.

27. The method of cleaning a fan blade of claim 26 further comprising simultaneously applying a polishing fluid to opposing major surfaces of the fan blade during the passing.

28. The method of cleaning a fan blade of claim 26 further comprising simultaneously applying a cleaning fluid to opposing major surfaces of the fan blade during the passing.

29. The method of cleaning a fan blade of claim 26 wherein passing a fan blade through a passage includes passing the fan blade between first and second cleaning pads secured within the passage.

30. The method of cleaning a fan blade of claim 29 comprising contacting the fan blade with a beveled cleaning pad edge to direct the fan blade into the passage.

31. The method of cleaning a fan blade of claim 29 further comprising removing the first and second cleaning pads from the passage and inserting new first and second cleaning pads into the passage.

32. A method of cleaning a fan blade comprising:
directing a fan blade into a first opening of a passage extending through a box shaped housing;
contacting opposing major surfaces of the fan blade with first and second cleaning pads secured within the passage;
removing the fan blade from the passage through a second opening; and
collecting debris from the opposing major surfaces of the fan blade in a dust gutter.

33. The method of cleaning a fan blade of claim 32 comprising directing a fan blade into a first opening larger than the second opening.

34. The method of cleaning a fan blade of claim 33 comprising collecting debris in a dust gutter adjacent the second opening as the fan blade is removed from the passage.
